(19) United States
(12) Patent Application Publication
(10) Pub. No.: US 2021/0072397 A1
(43) Pub. Date: Mar. 11, 2021

(54) GENERATION OF SYNTHETIC LIDAR SIGNALS

(71) Applicant: Robert Bosch GmbH, Stuttgart (DE)

(72) Inventors: Jan Niklas Caspers, Stuttgart (DE); Jasmin Ebert, Heidelberg (DE); Lydia Gauerhof, Sindelfingen (DE); Michael Pfeiffer, Schoenaich (DE); Remigius Has, Grafenau-Daetzingen (DE); Thomas Maurer, Stuttgart (DE); Anna Khoreva, Stuttgart (DE)

(21) Appl. No.: 17/009,351

(22) Filed: Sep. 1, 2020

(30) Foreign Application Priority Data
Sep. 5, 2019 (DE) 102019213546.3

(51) Int. Cl. G01S 17/894; G01S 17/931

(52) U.S. Cl. CPC G01S 17/894; G01S 7/483; G01S 17/931

(57) ABSTRACT

A generator for generating three-dimensional point clouds of synthetic LIDAR signals from a set of LIDAR signals measured with the aid of a physical LIDAR sensor. The generator includes a random generator and a first machine learning system, which receives vectors or tensors of random values from the random generator as input, and maps each such vector, or each such tensor, onto a three-dimensional point cloud of a synthetic LIDAR signal with the aid of an internal processing chain. The internal processing chain of the first machine learning system is parameterized by a plurality of parameters which are set in such a way that the three-dimensional point cloud of the LIDAR signal, and/or at least one characteristic variable derived from this point cloud, essentially has/have the same distribution for the synthetic LIDAR signals as for the measured LIDAR signals.

### CROSS REFERENCE

The present application claims the benefit under 35 U.S.C. § 119 of German Patent Application No. DE 102019213546.3 filed on Sep. 5, 2019, which is expressly incorporated herein by reference in its entirety.

### FIELD

The present invention relates to the generation of synthetic LIDAR signals which, in particular, are usable as training data for the object recognition in LIDAR signals with the aid of machine learning.

### BACKGROUND INFORMATION

To allow a vehicle to move in road traffic in an at least semi-automated manner, it is necessary to detect the surroundings of the vehicle and initiate countermeasures if a collision with an object in the surroundings of the vehicle is imminent. For safe automated driving, it is also necessary to create a surroundings representation and localization.

Furthermore, the distance and speed of objects may be directly derived from the LIDAR data. These pieces of information are important for the assessment as to whether a collision with the objects may occur. However, it is not directly apparent from LIDAR signals what type of object is involved. This identification is presently solved by the calculation of attributes from the digital signal processing, and finally represented in the form of a three-dimensional point cloud.

### SUMMARY

LIDAR signals may encompass a 3D point cloud, which is ascertained by measuring a distance from the sensor to a first reflective surface at a predefinable angle to the sensor surface. In this way, the LIDAR sensor is able to generate a 3D map in its immediate surroundings.

Within the scope of the present invention, a generator is provided for generating synthetic LIDAR signals from a set of LIDAR signals measured with the aid of a physical LIDAR sensor. In accordance with an example embodiment of the present invention, the generator includes a random generator and a first machine learning system, which receives vectors or tensors of random values from the random generator as input, and maps each such vector, or each such tensor, onto a histogram of a synthetic LIDAR signal with the aid of an internal processing chain.

The histogram representation may encompass a representation in a temporal space. The histogram representation is implemented by the detection of photons over time.

The internal processing chain of the first machine learning system is parameterized by a plurality of parameters. These parameters are set in such a way that the histogram representation of the LIDAR signal, and/or at least one characteristic variable derived from this representation, essentially has/have the same distribution for the synthetic LIDAR signals as for the measured LIDAR signals.

It was found that the necessary learning data are a scarce resource, in particular in the case of the object recognition from LIDAR signals with the aid of machine learning. Learning data for the object recognition from camera images usually encompass learning camera images which have been annotated (labeled) by people as to which objects are included in them in which locations. The visual identification of objects is particularly intuitive for humans, so that the requirements with regard to non-skilled workers for the annotation of camera images are comparatively low.

In contrast, identifying objects from LIDAR signals requires a higher post-processing effort of the raw data and specialized knowledge. This is related to the fact that the reflectivity of an object at the wavelength of a LIDAR, which may be outside the visible spectrum (for example in the range of 850 nm to 1600 nm), often does not agree with the reflectivity in the visible spectrum. Furthermore, it is possible that reflected LIDAR signals only return to the sensor after multiple reflections (for example at guard rails, walls or the road surface). Weather conditions, in particular, rain or fog, may often influence the propagation of the LIDAR signals in a manner which is very difficult to predict. A simulation of LIDAR signals with the aid of ray tracing is therefore very complex and at times has deviations from the actual behavior.

The LIDAR signal, which creates one and the same object, furthermore also depends on the properties of the used lasers and detectors, for example on the pulse sequence and wavelength of the laser or on the light sensitivity of the detector. The signal may be varied by multipath propagation, for example in that it was reflected multiple times at different surfaces (such as the roadway, a guard rail and/or a wall). Finally, the LIDAR signal is also material-dependent. Some materials reflect the emitted laser light with different intensity, while other materials almost completely absorb the laser light, which may then, in turn, cause present objects to be identified very poorly or not at all.

As a result, learning data for the object recognition from LIDAR signals are thus, on the one hand, more difficult to procure and, on the other hand, also require more learning data than for the object recognition from camera images.

In accordance with the present invention, this scarcity may be alleviated by the generator. In that the parameters of the first machine learning system are set in such a way that a distribution evident from the physically measured LIDAR signals is represented in the synthetic LIDAR signals, and in that additionally each generated LIDAR signal appears realistic in the sense that it is difficult to distinguish it from a proper LIDAR signal; it is possible to generate an arbitrary number of realistically appearing LIDAR signals, without requiring an annotation of the original physically measured LIDAR signals for this purpose. It is thus possible, for example, to additionally use measurements which sensor manufacturers and OEMs routinely carry out during test drives with LIDAR sensors for object recognition as a data base.

The characteristic variable may be an arbitrary variable derived from the histogram representation of the LIDAR signal. When this characteristic variable, for example, varies between the LIDAR signals measured by the physical LIDAR sensor, it puts these LIDAR signals into a relationship due to the resulting distribution. For example, the characteristic variable may encompass individual elements from the point cloud to which a distance, and a speed, relative to the physical LIDAR sensor, are assigned. A consistent distribution of the characteristic variable may then be formed with the aid of such LIDAR signals which relate to the same, or at least a similar, scenario.

The parameters of the internal processing chain may be learned by the generator itself. For this purpose, the generator only requires a feedback, of whatever kind, as to the extent to which the instantaneous parameters result in a distribution of the histogram, or of the characteristic variable, matching the measured LIDAR signals.

In one particularly advantageous embodiment, the first machine learning system receives at least one boundary condition as input. The parameters of the internal processing chain are set in such a way that the histogram representation, and/or the characteristic variable, essentially has/have the same distribution for the synthetic LIDAR signals as for those measured LIDAR signals which satisfy the boundary condition.

Using this expansion, it is possible, for example, to transfer an annotation present for the measured LIDAR signals into the generator. The boundary condition may be, for example, that the measured LIDAR signals are assigned to a certain class by virtue of the present annotation. It is then possible to generate an arbitrary number of synthetic LIDAR signals separately for each class, which complement the original inventory of measured and simultaneously annotated LIDAR signals. In this way, a sufficiently large data base may be created for the supervised learning of an object recognition, based on LIDAR signals.

The boundary condition, however, may also be used, for example, to estimate a LIDAR signal, based on the present measured LIDAR signals, for a situation for which there are no measurements. For example, the original set of measurements may include LIDAR signals which were obtained from a certain object in response to light waves which were incident upon the object under certain background lighting conditions. The boundary condition may, for example, be that an intermediate value which was not measured or a rarely occurring maximum value is assumed for the background light. The generator then basically interpolates or extrapolates the LIDAR signal, which results for this intermediate value or maximum value of the background light.

It is also possible, for example, to deliberately generate synthetic LIDAR signals for so-called extreme cases, which rarely occur in reality, but are of particular importance for the object recognition. These extreme cases may, for example, relate to situations which are particularly dangerous, and in which therefore a perfect function of a driver assistance system or of a system for at least semi-automated driving is required.

A 3D model of the physical scenario is not necessary to ensure that the synthetic LIDAR signals are rooted in reality, but it suffices that the distribution of the characteristic variable matches the measured LIDAR signals. In contrast to ray tracing simulations, also no detailed knowledge about the LIDAR sensor, its attachment location, materials, shape and backscatter coefficients of the objects to be identified are necessary.

The boundary condition may furthermore be used to filter the LIDAR signal using the output of another sensor, for example using the output of a camera, of a radar sensor, of a further LIDAR sensor or of an array of ultrasonic sensors.

In one particularly advantageous embodiment of the present invention, the first machine learning system includes an artificial neural network, whose internal processing chain includes at least one fully linked layer and/or at least one convolutional layer. It is an essential strength of artificial neural networks that they are able to bridge very large differences in the dimensionality between the input and the output. The vector or tensor including the random values may include, for example, 100 elements in the dimension, while the three-dimensional point cloud has a considerably higher dimensionality.

Advantageously, the random generator is a physical random generator, which generates the random values from thermal or electronic noise of at least one component, and/or from a chronological sequence of radioactive decays of an unstable isotope. In this way, it is avoided that artifacts of a pseudo random generator are superimposed onto the synthetic LIDAR signals generated by the generator.

The present invention also relates to a data set made up of a plurality of three-dimensional point clouds of synthetic LIDAR signals, which were created with the aid of the generator, and to a method for generating these synthetic LIDAR signals with the aid of the generator. This data set may, for example, be used directly as training data for the supervised learning of an object recognition and is thus an independently sellable product offering benefit for the customer. The better the generator operates, the more difficult it is to distinguish the synthetic LIDAR signals generated by it per se from the physically measured LIDAR signals. However, if a three-dimensional point cloud of a LIDAR signal on the one hand, and a generator, on the other hand, are provided, it is possible to ascertain at least a likelihood that the LIDAR signal was generated by this generator.

The present invention also relates to a method for creating the generator. In this method, three-dimensional point clouds of the measured LIDAR signals are combined with three-dimensional point clouds of the synthetic LIDAR signals generated by the generator in a pool. The three-dimensional point clouds included in the pool are classified with the aid of a classifier as to whether they belong to measured or to synthetic LIDAR signals. The parameters of the processing chain of the machine learning system in the generator are optimized to a preferably poor classification quality of the classifier.

The classification quality of the classifier thus serves as feedback for the learning of the parameters in the internal processing chain of the first machine learning system in the generator. This feedback may, for example, be an error signal of the classifier, or also, for example, a confidence measure generated in the classifier. In particular, the classifier and the generator may alternately be trained and thus basically serve as sparring partners for one another.

For example, the machine learning system may initially be initialized in the generator using standard values or random values for the parameters. If random values from the random generator are now supplied at the input of the machine learning system, there is a very high likelihood that the generated synthetic LIDAR signal will not have much to do with the measured LIDAR signals. Accordingly, the classifier will be able to distinguish, with great confidence, the three-dimensional point cloud belonging to the synthetic LIDAR signal from the three-dimensional point clouds belonging to the measured LIDAR signals, from the pool of three-dimensional point clouds. The more the parameters in the processing chain of the machine learning system are optimized, the more difficult this distinction will be for the classifier. This may manifest itself in that the classification is incorrect in a larger number of cases, and/or that the confidence with which the classification is carried out decreases.

The classifier may be of any design. For example, it may be a static classifier which classifies the three-dimensional point clouds as measured or synthetically generated by checking certain features, or also using statistical methods. When a boundary condition was predefined for the generator, the same boundary condition is also predefined for the classifier.

In one particularly advantageous embodiment of the present invention, a second machine learning system is selected as the classifier. This second machine learning program includes a further internal processing chain, which is parameterized by a plurality of parameters. These parameters are optimized to a preferably good classification quality of the classifier.

It is then possible, for example, to train both machine learning systems simultaneously or also alternately. In this way, a kind of competition is triggered between the first machine learning system and the second machine learning system. The first machine learning system continuously increases its learning to “imitate” realistic LIDAR signals, while the second machine learning system increases its learning to identify the “imitations.” In the end, the competition causes the obtained synthetic LIDAR signals to approximately exactly imitate the original physically measured LIDAR signals and to be usable together with these as learning data for the supervised learning of an object recognition.

The present invention also relates to a method for identifying objects, and/or a space free of objects of a predefined type, in the surroundings of a vehicle. The vehicle includes at least one LIDAR sensor for detecting at least a portion of the surroundings. In accordance with an example embodiment of the present invention, three-dimensional point clouds of LIDAR signals detected by the LIDAR sensor are classified by a third machine learning system as to which objects are present in the surroundings of the vehicle. The third machine learning system is trained using training data which were at least partially generated by a generator according to the present invention. The training data may, in particular, stem partially from physical measurements and partially from the generator.

In this way, it is possible to use the advantages of the LIDAR technology mentioned at the outset with the object recognition, without this necessarily coming at the expense of the learning data for the training of the object recognition being considerably more difficult to procure compared to the purely optical object recognition. A comparatively small set of physically measured LIDAR signals may be enriched by the generator to the quantity which is necessary for creating a reliable object recognition.

In response to the identification of at least one object, and/or of a space free of objects of a certain type, a physical warning unit perceptible to the driver of the vehicle, a drive system, a steering system, and/or a braking system of the vehicle is/are advantageously activated for the purpose of avoiding a collision between the vehicle and the object, and/or for the purpose of adapting the speed and/or trajectory of the vehicle. These purposes are the main reasons for seeking an object recognition at all.

As described above, predefining a boundary condition to the generator also allows the interpolation or extrapolation of a given set of measured scenarios to scenarios for which measurements do not exist yet. This may not only be used for evaluating LIDAR signals after the physical measurement, but also for improving the physical measurement per se. In contrast to a camera, which is purely a passive sensor, a LIDAR sensor is an active sensor, i.e., light waves emitted by the sensor itself serve as the measuring signal. Installation parameters and operating parameters of the LIDAR sensor thus have a considerable influence on the extent to which the obtained LIDAR signals are suitable for the ultimate object recognition.

The present invention, thus, also relates to a method for optimizing at least one installation parameter or operating parameter for a LIDAR sensor for the identification of objects, and/or of a space free of objects 72a, 72b of a certain type, in the surroundings of a vehicle. In accordance with an example embodiment of the present invention, in the method, at least one three-dimensional point cloud of a synthetic LIDAR signal is generated with the aid of a generator according to the present invention, and/or is retrieved from a data set previously generated by such a generator, for different values of the installation parameter or operating parameter. The identification of objects in the three-dimensional point cloud of the synthetic LIDAR signal is assessed using a quality criterion. The installation parameter or operating parameter is varied to the effect that the quality criterion assumes an extreme.

It is advantageous with respect to the ultimate goal of a reliable object recognition to not only consider the analysis of recorded LIDAR signals, but also the physical data collection itself. Pieces of information which are no longer identifiable in the recorded physical LIDAR signal may no longer be evaluated by an analysis, no matter how good it may be. Such a case may occur, for example, when the measuring range of the sensor, due to particularly high-contrast objects, is set to be so insensitive that a low-contrast person is lost in the noise. When the physical data collection and the subsequent analysis are comprehensively considered and optimized, the ultimately obtained object recognition may thus be improved even further.

It is made possible, via the quality criterion, in particular, to tailor the object recognition to certain objects, and to set priorities in the event of conflicting goals. A set of installation parameters or operating parameters cannot be perfect for all eventualities. For example, the reliable identification of a pedestrian, a bicyclist or another weaker road user may have priority over the identification of a concrete bollard. If the improved identification of weaker road users now is a top priority, the case may occur that this is only possible at the expense of other aspects, for example at the cost that some concrete bollards are not identified.

Even though the generator and the method each make use of hardware, and the deliberate use of accordingly optimized hardware is advantageous in each case, there are also operational specific embodiments of the generator and of the method which make do with the use of already existing hardware. The fact that the function according to the present invention is provided may thus be implemented entirely or partially in software which activates the hardware differently. This software may, for example, be sold as an update or upgrade of existing hardware and is thus an independent product. The present invention thus also relates to a computer program including machine-readable instructions which, when they are executed on a computer, and/or on a control unit, upgrade the computer, and/or the control unit, to a generator according to the present invention, and/or prompt it to carry out a method according to the present invention. The present invention also relates to a machine-readable data carrier or a download product including the computer program.

Further measures improving the present invention are shown hereafter in greater detail together with the description of the preferred exemplary embodiments of the present invention based on the figures.

### BRIEF DESCRIPTION OF THE DRAWINGS

FIG. 1 shows an exemplary embodiment of a generator 1 in accordance with the present invention.

FIG. 2 shows an exemplary embodiment of method 100 for creation in accordance with the present invention.

FIG. 3 shows an exemplary embodiment of method 200 for object recognition in accordance with the present invention.

FIG. 4 shows an exemplary embodiment of method 300 for optimization in accordance with the present invention.

### DETAILED DESCRIPTION OF EXAMPLE EMBODIMENTS

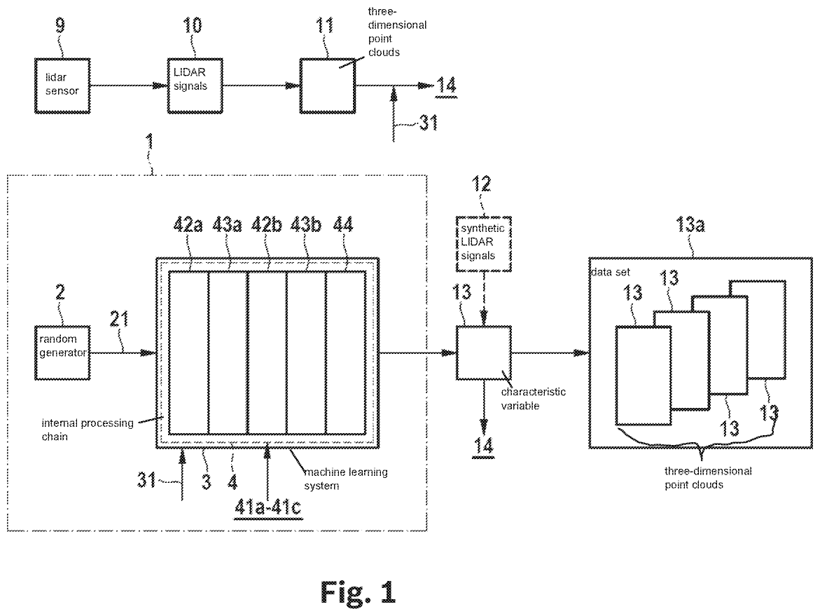

According to FIG. 1, generator 1 includes a random (value) generator 2 and a machine learning system 3 including an internal processing chain 4. Random generator 2 feeds random values 21 as input into machine learning system 3, which thereupon generates three-dimensional point clouds 13, taking an also input boundary condition 31 into consideration. These three-dimensional point clouds 13 correspond to synthetic LIDAR signals 12.

Machine learning system 3 includes, or is given by, a neural network whose internal processing chain 4 includes two convolutional layers 42a and 42b, two fully linked layers 43a and 43b, as well as an upsampling layer 44. Internal processing chain 4 is parameterized by a plurality of parameters 41a through 41c. However, other architectures are also possible which, for example, include only one convolutional layer 42a, 42b and no fully linked layer 43a, 43b, or only one fully linked layer 43a, 43b and no convolutional layer 42a, 42b, and in which an upsampling layer 44 is missing.

A characteristic variable 14 is derivable from three-dimensional point cloud 13 generated by generator 1. A similar characteristic variable 14 is also derivable from the three-dimensional point clouds 11 of LIDAR signals 10 measured by a physical LIDAR sensor 9, also those point clouds 11 being selected here which match predefined boundary condition 31.

Parameters 41a through 41c of internal processing chain 4 in machine learning system 3 of generator 1 are set in such a way that three-dimensional point cloud 11, 13, and/or characteristic variable 14, essentially has/have the same distribution for synthetic LIDAR signals 12 as for measured LIDAR signals 10.

A plurality of three-dimensional point clouds 13 generated with the aid of generator 1 is combined into a data set 13a. With this data set 13a, for example, the database for the supervised learning of an object recognition based on LIDAR signals may be increased.

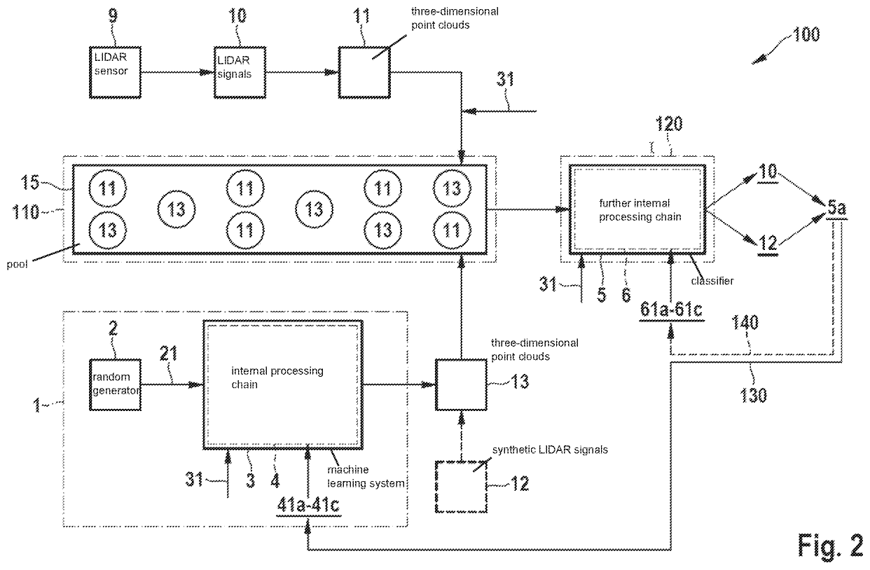

FIG. 2 shows an exemplary embodiment of method 100 for creating generator 1. The main goal of this method 100 is to obtain parameters 41a through 41c for internal processing chain 4 of machine learning system 3 in generator 1.

Similarly to FIG. 1, three-dimensional point clouds 13 of synthetic LIDAR signals 12 are generated by generator 1, taking boundary condition 31 into consideration. These are combined, in step 110 of method 100, into a pool 15, together with three-dimensional point clouds 11 of physically measured LIDAR signals 10 which match the same boundary condition 31.

In step 120 of method 100, three-dimensional point clouds 11, 13 included in pool 15 are classified by a classifier 5 as to whether they belong to measured LIDAR signals 10 or to synthetic LIDAR signals 12. A classification quality 5a may be indicated for this classification, which may, for example, include the accuracy, and/or the confidence, of the classification.

Parameters 41a through 41c of internal processing chain 4 in machine learning system 3 of generator 1 are now optimized, in step 130 of method 100, to a preferably poor classification quality 5a of classifier 5.

Classifier 5 may be a static classifier, which does not increase its learning. In the exemplary embodiment shown in FIG. 2, classifier 5, however, is designed as a second machine learning system and includes a further internal processing chain 6, which is parameterized by a plurality of parameters 61a through 61c. These parameters 61a through 61c are optimized in step 140 of method 100 to a preferably good classification quality 5a of classifier 5.

Steps 130 and 140 may, for example, be carried out simultaneously or also alternatingly.

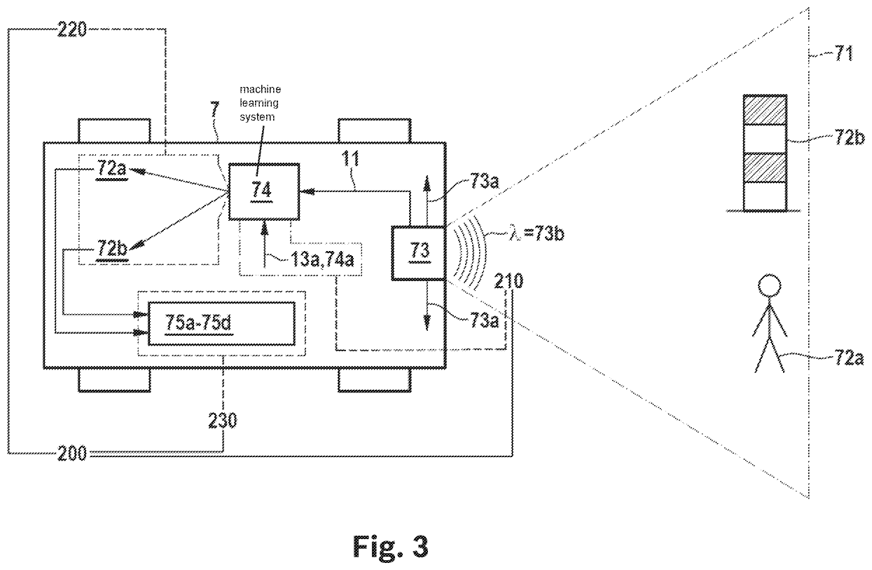

FIG. 3 shows an exemplary embodiment of method 200 for identifying objects 72a, 72b, and/or of a space free of objects 72a, 72b of a certain type, in surroundings 71 of a vehicle 7. A LIDAR sensor 73 is used at the data source for the identification, which supplies three-dimensional point clouds 11 of the measured LIDAR signals to a third machine learning system 74. This third machine learning system 74 has been trained using training data 74a which encompass a data set 13a generated by a generator 1. In addition to data set 13a, training data 74a may, in particular, also encompass physical measurements, so that data set 13a ultimately supplements the physical measurements. Third machine learning system 74 may also only be accordingly trained in step 210 of method 200.

In step 220 of method 200, third machine learning system 74 classifies three-dimensional point clouds 11 as to which objects 72a, 72b are present in the detected surroundings 71 of vehicle 7. A pedestrian 72a and a concrete bollard 72b are plotted in FIG. 3 as exemplary objects.

The result of the classification is used in step 230 of method 200 to activate a warning unit 75a for the driver of vehicle 7, a drive system 75b, a steering system 75c, and/or a braking system 75d, of vehicle 7, for the purpose of avoiding a collision with the identified objects 72a, 72b, and/or for the purpose of adapting the speed and/or trajectory of vehicle 7. For example, the speed may be adjusted to a setpoint value, and/or a driver assistant may select a lane. In addition to the LIDAR signals, it is also possible to use additional pieces of information from other sensors, such as cameras, radar or ultrasound, for these tasks.

The physical data collection by LIDAR sensor 73 is influenced, among other things, by installation parameters 73a, here for example the installation position of LIDAR sensor 73a, and operating parameters 73b, here for example wavelength λ of the emitted light waves. Installation parameters 73a and operating parameters 73b are thus further degrees of freedom which may be optimized to improve the ultimate result of the object recognition or other applications, such as the lane guidance.

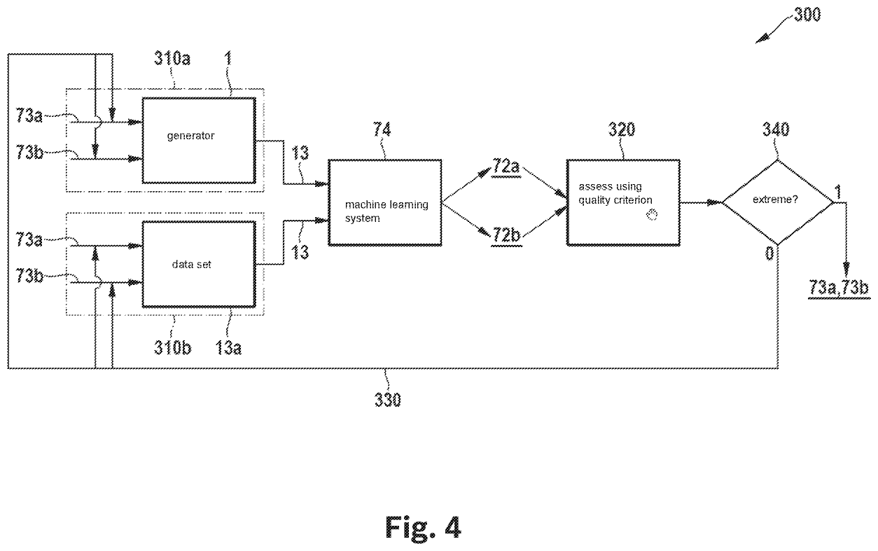

FIG. 4 outlines an exemplary embodiment of method 300 for this optimization. Based on a value of installation parameter 73a, and/or of operating parameter 73b, in step 310a of method 300, a three-dimensional point cloud of a synthetic LIDAR signal 12 is generated with the aid of generator 1, and/or in step 310b of method 300, such a three-dimensional point cloud 13 is retrieved from a data set 13a previously generated by a generator 1.

With the aid of third machine learning system 74, which is also to be used during an actual use in vehicle 7, three-dimensional point cloud 13 is classified as to which objects 72a, 72b are identifiable therein. This identification of objects 72a, 72b is assessed using a quality criterion in step 320 of method 300. In step 340 of method 300, it is checked whether this quality criterion assumes an extreme, as desired. If this is the case (truth value 1), the tested value of installation parameter 72a, or of operating parameter 73b, is found to be optimal. If, in contrast, the desired extreme is not accepted (truth value 0), installation parameter 73a, or operating parameter 73b, is varied in step 330 of method 300 to get closer to the desired extreme or achieve it during the next pass.

What is claimed is:

1. A generator for generating three-dimensional point clouds of synthetic LIDAR signals from a set of LIDAR signals measured using a physical LIDAR sensor, comprising:
a random generator; and
a first machine learning system configured to receive, as input, vectors of random values or tensors of the random values, from the random generator, and configured to map each of the vectors or tensors onto a respective three-dimensional point cloud of a synthetic LIDAR signal using an internal processing chain, the internal processing chain of the first machine learning system being parameterized by a plurality of parameters which are set in such a way that a three-dimensional point cloud and/or at least one characteristic variable derived from the point cloud has the same distribution for the synthetic LIDAR signals as for the measured LIDAR signals.

2. The generator as recited in claim 1, wherein the characteristic variable includes one or more elements of the point cloud to which a distance and a speed relative to the physical LIDAR sensor are assigned.

3. The generator as recited in claim 1, wherein the first machine learning system is configured to receive, as input, at least one boundary condition, and wherein the parameters of the internal processing chain are set in such a way that the point cloud and/or the characteristic variable, have the same distribution for the synthetic LIDAR signals as for those measured LIDAR signals which satisfy the boundary condition.

4. The generator as recited in claim 1, wherein the first machine learning system includes an artificial neural network, whose internal processing chain includes at least one convolutional layer and/or at least one fully linked layer.

5. The generator as recited in claim 1, wherein the random generator is a physical random generator, which generates the random values from thermal or electronic noise of at least one component, and/or from a chronological sequence of radioactive decay of an unstable isotope.

6. A method for creating a three-dimensional point cloud of synthetic LIDAR signals, comprising the following steps:
providing a generator for generating three-dimensional point clouds of synthetic LIDAR signals from a set of LIDAR signals measured using a physical LIDAR sensor, the generator including a random generator, and a first machine learning system configured to receive, as input, vectors of random values or tensors of the random values, from the random generator, and configured to map each of the vectors or tensors onto a respective three-dimensional point cloud of a synthetic LIDAR signal using an internal processing chain, the internal processing chain of the first machine learning system being parameterized by a plurality of parameters which are set in such a way that a three-dimensional point cloud and/or at least one characteristic variable derived from the point cloud has the same distribution for the synthetic LIDAR signals as for the measured LIDAR signals; and
generating the three dimensional point cloud of synthetic LIDAR signals using the generator.

7. A method for creating a generator, comprising:
combining three-dimensional point clouds of measured LIDAR signals into a pool with three-dimensional point clouds of synthetic LIDAR signals generated by the generator, the generator including a random generator, and a first machine learning system configured to receive, as input, vectors of random values or tensors of the random values, from the random generator, and configured to map each of the vectors or tensors onto a respective three-dimensional point cloud of a synthetic LIDAR signal using an internal processing chain, the internal processing chain of the first machine learning system being parameterized by a plurality of parameters which are set in such a way that a three-dimensional point cloud and/or at least one characteristic variable derived from the point cloud has the same distribution for the synthetic LIDAR signals as for the measured LIDAR signals;
classifying, using a classifier, each of the three-dimensional point clouds of the measured LIDAR signals in the pool and the three-dimensional point clouds of the synthetic LIDAR signals in the pool, as to whether it belongs to measured LIDAR signals or to synthetic LIDAR signals; and
optimizing the parameters of the internal processing chain of the first machine learning system in the generator for a poor classification quality of the classifier.

8. The method as recited in claim 7, wherein a second machine learning system is selected as the classifier, the second machine learning system including a further internal processing chain which is parameterized by a plurality of parameters optimized to a good classification quality of the classifier.

9. A method for identifying objects and/or a space free of objects of a certain type, in surroundings of a vehicle, the vehicle including at least one LIDAR sensor configured to detect at least a portion of the surroundings, the method comprising:
classifying, by a third machine learning system, three-dimensional point clouds of LIDAR signals detected by the LIDAR sensor as to which objects are present in the surroundings of the vehicle, the third machine learning system being trained using training data generated by:
providing a generator for generating three-dimensional point clouds of synthetic LIDAR signals from a set of LIDAR signals measured using a physical LIDAR sensor, the generator including a random generator, and a first machine learning system configured to receive, as input, vectors of random values or tensors of the random values, from the random generator, and configured to map each of the vectors or tensors onto a respective three-dimensional point cloud of a synthetic LIDAR signal using an internal processing chain, the internal processing chain of the first machine learning system being parameterized by a plurality of parameters which are set in such a way that a three-dimensional point cloud and/or at least one characteristic variable derived from the point cloud has the same distribution for the synthetic LIDAR signals as for the measured LIDAR signals; and
generating the three dimensional point cloud of synthetic LIDAR signals using the generator.

10. The method as recited in claim 9, wherein, in response to the identification of at least one object and/or of a space free of objects of a certain type: (i) a physical warning unit perceptible to a driver of the vehicle, and/or (ii) a drive system of the vehicle, and/or (iii) a steering system of the vehicle, and/or (iv) a braking system of the vehicle is activated for: (i) avoiding a collision between the vehicle and the object, and/or (ii) adapting a speed of the vehicle and/or a trajectory of the vehicle.

11. A method for optimizing at least one installation parameter for a LIDAR system or operating parameter for the LIDAR sensor, for identification of objects and/or a space free of objects of a certain type, in surroundings of a vehicle, the method comprising:
generating at least one three-dimensional point cloud of a synthetic LIDAR signal using a generator, the generator including a random generator, and a first machine learning system configured to receive, as input, vectors of random values or tensors of the random values, from the random generator, and configured to map each of the vectors or tensors onto a respective three-dimensional point cloud of a respective synthetic LIDAR signal using an internal processing chain, the internal processing chain of the first machine learning system being parameterized by a plurality of parameters which are set in such a way that a three-dimensional point cloud and/or at least one characteristic variable derived from the point cloud has the same distribution for the synthetic LIDAR signals as for the measured LIDAR signals; and
in each case, for different values of the installation parameter or operating parameter, assessing an identification of objects in the three-dimensional point cloud of the synthetic LIDAR signal using a quality criterion, and varying the installation parameter or operating parameter to the effect that the quality criterion assumes an extreme.

12. A non-transitory machine-readable storage medium on which is stored a computer program including machine-readable instructions for creating a generator, the computer program, when executed by a computer, causing the computer to perform:
combining three-dimensional point clouds of measured LIDAR signals into a pool with three-dimensional point clouds of synthetic LIDAR signals generated by the generator, the generator including a random generator, and a first machine learning system configured to receive, as input, vectors of random values or tensors of the random values, from the random generator, and configured to map each of the vectors or tensors onto a respective three-dimensional point cloud of a synthetic LIDAR signal using an internal processing chain, the internal processing chain of the first machine learning system being parameterized by a plurality of parameters which are set in such a way that a three-dimensional point cloud and/or at least one characteristic variable derived from the point cloud has the same distribution for the synthetic LIDAR signals as for the measured LIDAR signals;
classifying, using a classifier, each of the three-dimensional point clouds of the measured LIDAR signals in the pool and the three-dimensional point clouds of the synthetic LIDAR signals in the pool as to whether they belong to measured or to synthetic LIDAR signals; and
optimizing the parameters of the internal processing chain of the first machine learning system in the generator for a poor classification quality of the classifier.
